(19) United States
(12) Patent Application Publication
(10) Pub. No.: US 2020/0167623 A1
(43) Pub. Date: May 28, 2020

(54) NFC TRANSPONDER ASSEMBLY

(71) Applicant: AIT AUSTRIAN INSTITUTE OF TECHNOLOGY GMBH, WIEN (AT)

(72) Inventors: ANDREAS OBERLEITNER, ZILLINGDORF (AT); ROBERT LURF, GLOGGNITZ (AT); MARTIN BEISTEINER, BAD SCHOENAU (AT); CHRISTOPH MATOSCHITZ, TATTENDORF (AT)

(21) Appl. No.: 16/632,768

(22) PCT Filed: Jul. 11, 2018
(86) PCT No.: PCT/AT2018/060144

§ 371 Date: Jan. 21, 2020

(30) Foreign Application Priority Data
Jul. 20, 2017 (AT) A50607/2017

(51) Int. Cl. G06K 19/07; G06K 19/073; G06K 19/077; H04B 5/00

(52) U.S. Cl. CPC G06K 19/0723; G06K 19/0708; G06K 19/07345; G06K 19/0716; H04B 5/0081; H04B 5/0031; H04B 5/0037; G06K 19/0775

(57) ABSTRACT

An NFC transponder assembly includes an NFC communication unit and an antenna coil connected to the communication unit. The assembly draws energy from an electromagnetic field at the antenna coil via the antenna coil and establishes an NFC communication link with a data communication device via the antenna coil. A first switch is activated to activate the antenna coil. A second electric switch, parallel to the first switch, is open in the inactive state. The assembly closes the second switch after the first switch is actuated and keeps the second switch closed for a period of time after terminating the actuation of the first switch such that the antenna coil is activated for that period of time and ready to transmit data. The assembly opens the second switch after the period of time has expired such that the antenna coil is deactivated and no longer ready to transmit data.

The invention relates to a device as claimed in the preamble of patent claim 1.

The prior art discloses devices for NFC communication with a data communication device, in the case of which data are exchanged contactlessly. The data here are stored on an electronic data carrier, a so-called transponder. The energy supply of the data carrier and the data exchange between the transponder and the data communication device are carried out, with the transponder being arranged spatially near the data communication device, via coupled coils by means of electromagnetic induction. The transponder usually does not have its own energy supply and is activated by the data communication device only within the response range thereof. The energy required for operating the transponder is drawn from the electric or magnetic field of the data communication device.

NFC communication is used for example in contactless smart cards for use as a ticket on public transport or for storing personal data, for cashless payment for example by means of contactless smart cards or mobile radio devices at NFC-enabled checkouts, but also in medical technology for transferring measurement data or for monitoring the taking of medication.

What is disadvantageous about devices known from the prior art is that the transponder becomes inactive once NFC communication with a data communication device has been established and data have been transferred between the transponder and the data communication device. It is only by the transponder being removed from the response range of the data communication device that the transponder becomes active again, such that it can once again establish NFC communication with the data communication device.

A further disadvantage of devices known from the prior art is that for the time period during which a transponder is in NFC communication with a data communication device, NFC communication with a further data communication device cannot be established, even if the actual NFC communication with the first data communication device has already concluded. It is likewise not possible, while a transponder is in NFC communication with a data communication device, to establish NFC communication with a further transponder, even if the actual NFC communication with the first transponder has already concluded. In this regard, it is not possible, for example while measurement data are being transferred via the NFC interface by means of an NFC-enabled smart phone, to establish a further NFC communication and e.g. to carry out a contactless payment at an NFC checkout.

It is an object of the invention to provide a remedy in this regard and to make available an NFC transponder assembly which enables an NFC communication to be repeatedly interrupted and re-established, without being removed from the near range of the data communication device.

In the case of an NFC transponder assembly according to the invention, these aims are achieved by means of the characterizing features of claim 1. The invention relates to an NFC transponder assembly comprising an NFC communication unit and an antenna coil connected to the NFC communication unit, wherein the NFC transponder assembly is configured to draw energy from an electromagnetic field in the region of the antenna coil via the antenna coil and to establish NFC communication with a data communication device via the antenna coil, comprising a first switch configured to activate the antenna coil upon actuation.

According to the invention, furthermore, a second switch is provided, which is open in the inactive state, wherein the second switch is configured as an electrical switch and is arranged in parallel with the first switch, wherein the NFC transponder assembly is configured, after the actuation of the first switch, to close the second switch and in particular to keep it closed for a time period after the end of the actuation of the first switch, such that the antenna coil is activated for said time period and in particular is ready for data transfer, and

wherein the NFC transponder assembly is configured to open the second switch after the end of the time period, such that the antenna coil is deactivated and in particular is not ready for data transfer.

The invention makes it possible for energy to be transferred permanently to the NFC communication unit via the antenna coil simply by the first switch being pressed. In this case, the first switch can also be embodied as a pushbutton switch.

One advantageous embodiment of the NFC transponder assembly, enabling direct energy transfer and, if necessary, later data transfer from the antenna coil to the NFC communication unit, provides for the first switch to be connected in series with the antenna coil, and for the first switch to be configured to activate the antenna coil upon actuation.

For the same purpose, provision can also be made for the first switch to be connected in parallel with the antenna coil and to be configured to short-circuit the antenna coil, in particular via a resistor, in the initial state and to open upon actuation and to activate the antenna coil in this way.

This embodiment can be used when a break-contact switch or interrupter is available. Such an interrupter can also be realized by a fuse, for example.

Likewise, for the same purpose, provision can be made for the second switch and/or the first switch, preferably both, to be configured as an all-pole switch respectively comprising two second switch elements and/or two first switch elements, wherein both terminals of the antenna coil are connected respectively via the second switch elements and/or the first switch elements to the terminals of the NFC communication unit, and wherein the second switch elements and/or the first switch elements are closed simultaneously upon actuation.

This circuit enables a complete galvanic isolation of antenna coil and NFC communication unit.

Finally, for the same purpose, provision can also be made for a further circuit element, in particular a coil or a capacitor, to be provided, wherein the first switch is configured to activate the circuit element upon actuation and to tune the antenna coil to a predefined resonant frequency as a result of the activation of the circuit element, such that the antenna coil is activated and in particular is ready for data transfer.

With such an embodiment, it is also possible, if necessary, to switch data transfer on or off, while energy transfer—albeit to a poorer degree—is constantly ensured.

An embodiment of the invention which is simple and producible in a modular design can be achieved by virtue of the NFC communication unit having at least two terminals for the antenna coil,

wherein one terminal of the first switch is connected to one of the terminals of the NFC communication unit,

wherein the other terminal of the first switch is connected to one of the terminals of the antenna coil, and

wherein the other terminal of the antenna coil is connected to the other terminal of the NFC communication unit.

An alternative advantageous embodiment of the NFC transponder assembly, which is triggered by the presence of an object or a liquid in the region of the first switch, is provided by virtue of the first switch being formed by an open electrode pair, wherein the open electrode pair is formed in such a way

that when a conductive liquid is present in the region of the electrodes, current flows between the two electrodes of the open electrode pair, in particular in such a way that the antenna coil is activated and ready for data transfer, and/or

that the antenna coil is detuned and, when an object or a liquid having an increased permittivity in comparison with air is present, the first switch changes its capacitance in such a way that the antenna coil is tuned to a predefined resonant frequency, such that the antenna coil is activated and in particular is ready for data transfer.

In order to be able to store energy provided by the antenna coil by means of the NFC transponder assembly and optionally, at a later point in time, to be able once again to establish a communication without a further activation, provision is made for an energy store to be provided, and for the NFC transponder assembly to be configured to store energy provided via the antenna coil in the energy store. Automated logging of measurement values can also be achieved by means of such a measure.

Maximum flexibility in the applicability of the invention in association with the use of sensors is achieved by virtue of the fact that a pressure-sensitive switch or pushbutton switch is provided as the first switch, wherein the switch closes upon pressure being exerted, and/or

that a switch controlled by a sensor, in particular a light-sensitive switch, is provided as the first switch, wherein the switch is configured to close if a measurement value determined by the sensor exceeds a predefined threshold value, in particular when light is incident on the sensor, wherein optionally the sensor is connected to the energy store in order to supply with energy a measuring device for determining the measurement value, said measuring device being contained in the sensor, or

that as the first switch provision is made of an external proximity switch, in particular that provision is made of a resistive proximity switch or a capacitive proximity switch or an inductive proximity switch.

In order to indicate the state of charge in the energy store of the NFC transponder assembly, it may be advantageous for provision to be made of an indicator unit configured to indicate the presence of available energy stored in the energy store or present at the antenna coil.

The possibility of being able to harvest energy from the pulses of a data communication device by means of the NFC transponder assembly, without the antenna coil being activated via the first switch, is achieved by virtue of provision being made of an energy drawing device for drawing energy from the antenna coil,

wherein the energy drawing device is directly connected to the terminals of the antenna coil,

wherein the energy drawing device is configured to store the provided energy in the energy store, and

wherein the energy drawing device is configured to control the second switch in the case of a sufficient state of charge, such that said second switch is closed and the NFC communication unit and the antenna coil are connected.

The possibility for recording and transferring measurement data by means of an NFC transponder assembly is advantageously provided by a measuring device for determining a measurement variable, said measuring device being connected to the NFC communication unit, wherein the NFC transponder assembly is configured to transmit the measurement results present at the output of the measuring device, in particular upon request, to a data communication device via the antenna coil.

In order to operate the measuring device with the NFC transponder assembly without an external power supply, provision is made for the measuring device

to be connected to the energy store or

to be supplied with energy directly by the antenna coil and, during the measurement process, to be supplied with electrical energy by this.

In order to keep the NFC transponder assembly available for a further NFC communication outside the measurement and data transfer time of the measuring device, provision is made for the NFC communication unit to be configured to activate the measuring device and to open the second switch after a predefined time period, wherein the predefined time period corresponds in particular to the time required by the measuring device to carry out its measurement and/or data transfer.

In order to activate the antenna coil without the need for renewed manual actuation of the first switch of the NFC transponder assembly, provision is made for the NFC communication unit to be configured to close the second switch once again, after the opening, using the energy stored in the energy store.

A further compact and easily producible embodiment of the invention comprises—an NFC transponder assembly as claimed in any of the preceding claims,

a further NFC communication unit, and

a further antenna coil connected to the further NFC communication unit,

wherein the further antenna coil, in particular permanently, is arranged in the region of the antenna coil of the NFC transponder assembly and/or is connected thereto and is coupled thereto, in particular in such a way that upon activation of the antenna coil of the NFC transponder assembly, there is a communication link between the NFC communication unit and the further NFC communication unit via the two antenna coils.

In order that already existing data communication devices can also be equipped with an NFC transponder assembly, it is provided that as a result of the NFC transponder assembly being fixed on the data communication device, in particular by being adhesively bonded or plugged thereon, the antenna coil is arranged permanently in the near range of the further antenna coil, and wherein the NFC transponder assembly is arranged in particular on an adhesive label adhesively bonded onto the data communication device, or on a protective cover fitted on the data communication device, or on a plug-on unit fitted on the data communication device.

Further advantages and configurations of the invention are evident from the description and the accompanying drawings.

The invention hereinafter is illustrated schematically in the drawings on the basis of particularly advantageous exemplary embodiments, which however should not be understood to be restrictive, and is described by way of example with reference to the drawings:

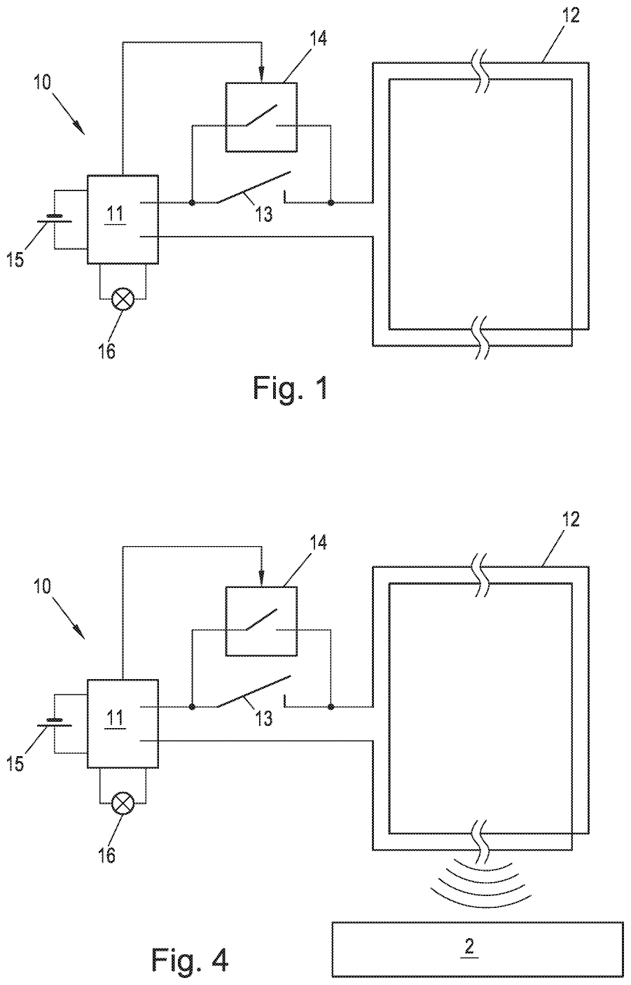

FIG. 1 shows a first exemplary embodiment of an NFC transponder assembly according to the invention.

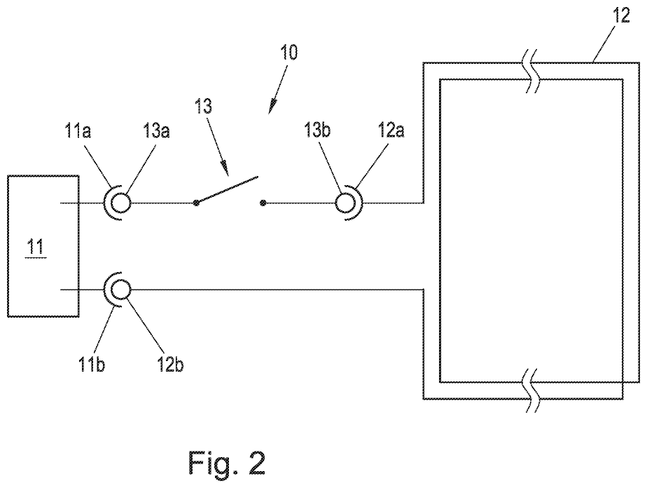

FIG. 2 shows in detail one exemplary arrangement of the terminals of an NFC transponder assembly

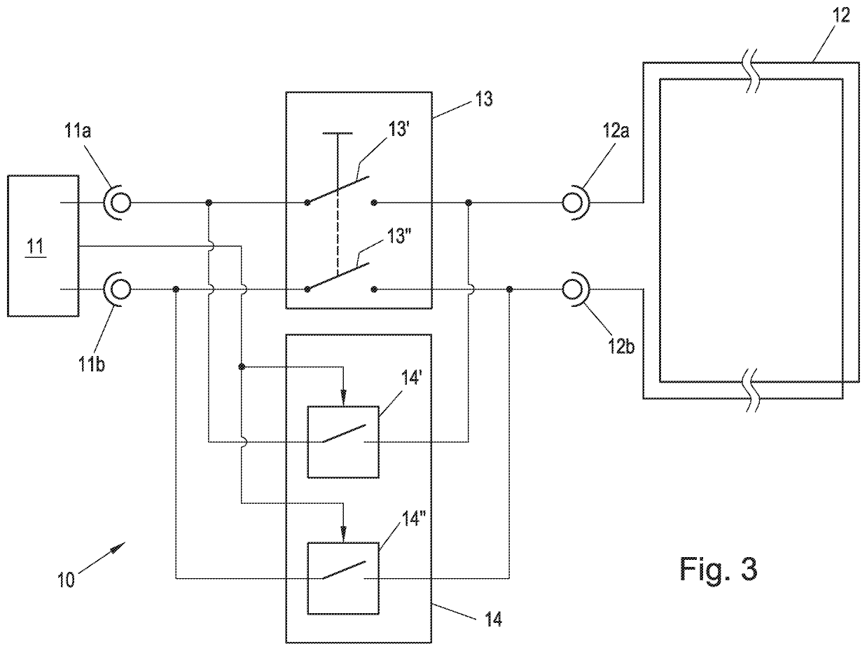

FIG. 3 shows one exemplary embodiment with all-pole switches.

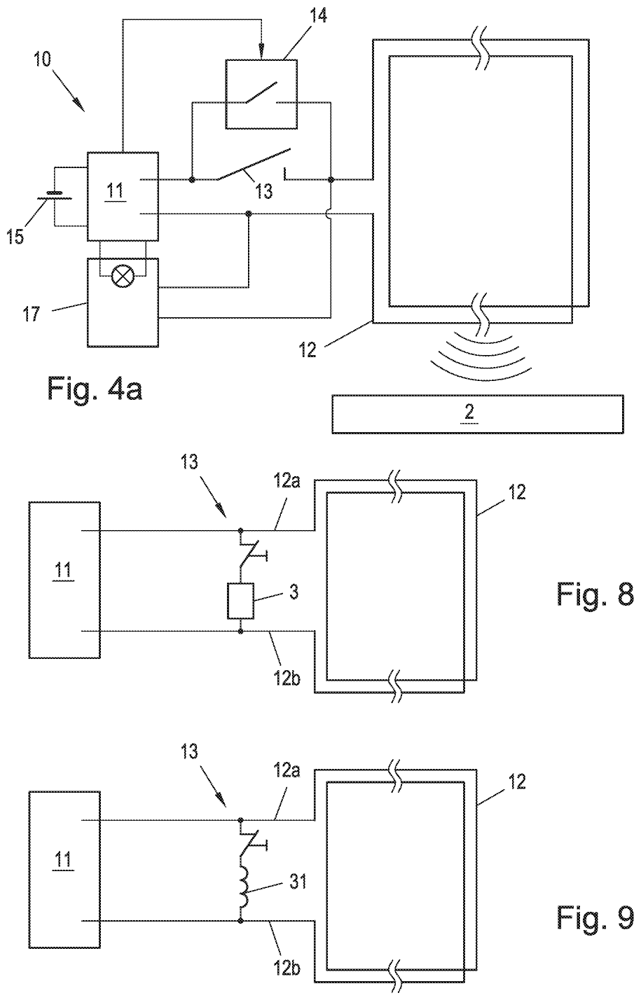

FIGS. 4 and 4a show further exemplary embodiments with a measuring device.

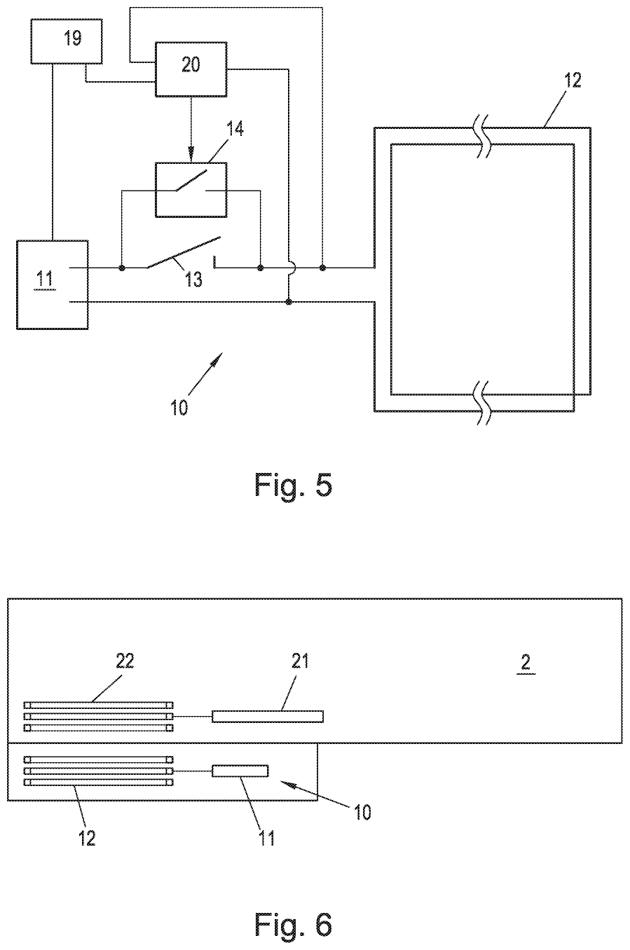

FIG. 5 shows an alternative exemplary embodiment with a microcontroller and a control unit.

FIG. 6 shows a data communication device with an NFC transponder assembly according to the invention.

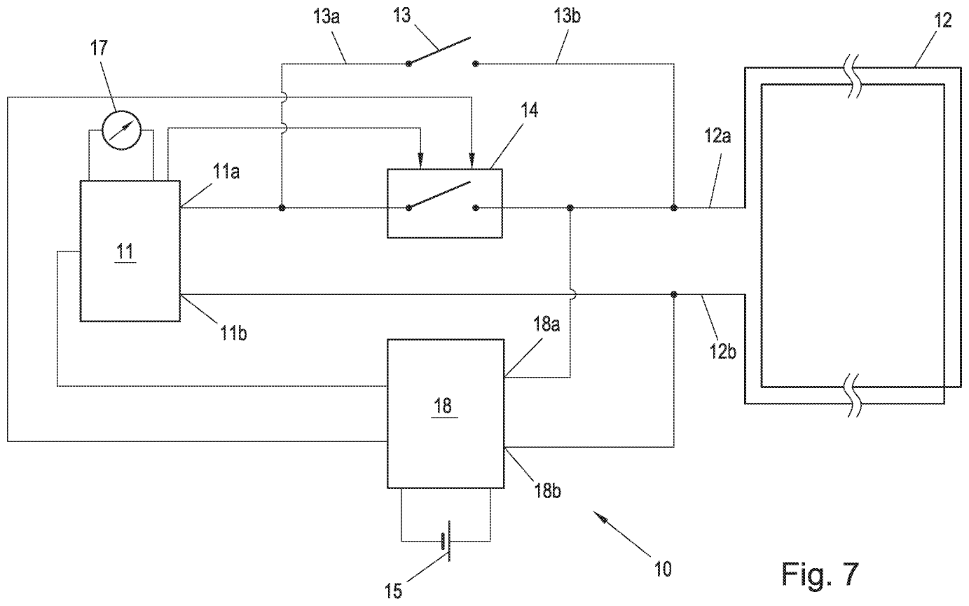

FIG. 7 shows one exemplary embodiment with an energy drawing device.

FIG. 8 and FIG. 9 respectively show an exemplary embodiment with a first switch connected in parallel with the antenna coil.

FIG. 1 schematically illustrates a first exemplary embodiment of an NFC transponder assembly 10 according to the invention. The NFC transponder assembly 10 comprises an NFC communication unit 11, an antenna coil 12, a first switch 13, an electrical second switch 14, an energy store 15 and an indicator unit 16. In the exemplary embodiment, the first switch 13 is configured as a mechanical pushbutton switch, which is open in the unactuated state and is closable by manual actuation. The electrical second switch 14 is likewise open in the inactive state and is arranged in parallel with the first switch 13.

The first switch 13 and the second switch 14 are arranged in the electrical circuit of the NFC transponder assembly 10 in such a way that in the open state of the first switch 13 and of the second switch 14, the antenna coil 12 is deactivated and is not ready for data communication.

After manual actuation of the first switch 13, the antenna coil 12 is activated and provides energy, such that the NFC communication unit 11 is likewise activated by the supply of energy. Since the manual actuation of the first switch 13 embodied as a pushbutton switch activates the antenna coil 12 only for a short time period, the NFC communication unit 11 advantageously drives the electrical second switch 14 and closes the second switch 14. The NFC communication unit 11 subsequently keeps the second switch 14 closed for a time period after the end of the actuation of the first switch 13. As a result, for this time period the antenna coil 12 is activated and ready for energy and data transfer with a data communication device 2, for example.

The NFC communication unit 11 is advantageously configured, after the end of the time period in which data are transferred, for example, to drive and to open the second switch 14, such that the antenna coil 12 is deactivated again and in particular is no longer ready for data transfer. This configuration ensures that the NFC communication via the antenna coil 12 is maintained only as long as data are actually transferred. After the data transfer, the NFC connection is ended, such that a new connection to a different transponder is possible.

In the exemplary embodiment shown, the NFC transponder assembly 10 stores energy provided via the antenna coil 12 in the energy store 15. The indicator unit 16 indicates the presence of energy stored in the energy store 15 or of available energy present at the antenna coil 12. The NFC transponder assembly 10 is configured to close the second switch 14 once again, after opening, using the energy stored in the energy store 15, if enough energy is present.

As a result, for example, at predefined time intervals, data transfer via the antenna coil 12 can once again be established as long as the state of charge in the energy store 15 is sufficient for closing the second switch 14, without the need for renewed manual actuation of the first switch 13.

FIG. 2 shows in detail one exemplary arrangement of the terminals of an NFC transponder assembly 10 comprising an NFC communication unit 11, a first switch 13 and an antenna coil 12. In the concrete exemplary embodiment, the NFC communication unit 11 and the antenna coil 12 respectively have two terminals 11a, 11b and 12a, 12b, in order to connect the NFC communication unit 11 and the antenna coil 12 to one another.

One terminal 13a of the first switch 13 is connected to the first terminal 11a of the NFC communication unit 11 and a further terminal 13b of the first switch 13 is connected to the terminal 12a of the antenna coil 12. The second terminal 12b of the antenna coil 12 is connected to the second terminal 11b of the NFC communication unit 11. This embodiment enables the antenna coil 12 to be activated by the actuation of the first switch 13, such that the antenna coil 12 in particular is ready for data transfer.

FIG. 3 shows one configuration variant for an NFC transponder assembly 10 according to the invention, in which both the first switch 13 and the second switch 14 are embodied as all-pole switches. The first switch 13 is embodied as an all-pole mechanical switch and the second switch 14 is embodied as an all-pole electrical switch. Both terminals 12a and 12b of the antenna coil 12 are respectively connected to the terminals 11a and 11b of the NFC communication unit 11 via two first switch elements 13′, 13″ and two second switch elements 14′, 14″. Upon actuation of the all-pole mechanical first switch 13, both first switch elements 13′, 13″ are short-circuited simultaneously, such that the antenna coil 12 is activated and in particular is ready for data transfer. In this case, energy is provided by the antenna coil 12, such that the NFC communication unit 11 is activated and controls the all-pole second switch 14, such that both second switch elements 14′, 14″ are simultaneously closed and the antenna coil 12 is activated further and is ready for data transfer, even if the all-pole first switch 13 is no longer actuated.

FIG. 4 and FIG. 4a schematically illustrate an alternative variant of an NFC transponder assembly 10 comprising an NFC communication unit 11, a measuring device 17, a mechanical first switch 13, an electrical second switch 14 and an antenna coil 12. In the exemplary embodiment illustrated in FIG. 4, the measuring device 17 is connected to the NFC communication unit 11 and an energy store 15, such that the measuring device 17 is supplied with electrical energy by the energy store 15 during the measurement process.

The measuring device 17 is configured for determining a measurement variable and the measurement results are present at the output of the measuring device 17 after a measurement process. The NFC transponder assembly 10 is configured optionally to process the measurement results present at the output of the measuring device 17 and in particular upon request to transmit them to a data communication device 2 via the antenna coil 12.

Advantageously, provision can also be made for the NFC transponder assembly 10 to be configured to activate the measuring device 17 in order to carry out a measurement, and to open the second switch 14 after a predefined time period, wherein the predefined time period corresponds in particular to the time required by the measuring device 17 to carry out its measurement and/or transfer of the measurement data. In this way, it is ensured that the second switch 14 is closed and hence the antenna coil 12 is ready for data transfer only as long as measurements or a transfer of measurement data are/is actually carried out. Otherwise, the second switch 14 is open, such that the antenna coil 22 of the data communication device 2 is not blocked and is available for establishing some other NFC communication.

As illustrated in FIG. 4, provision can advantageously also be made for the NFC transponder assembly 10 to be configured to close the second switch 14 once again, after the opening, using the energy stored in the energy store 15. What is achieved as a result is that, for example, a further measurement process with a subsequent data transfer can be initiated as long as there is enough energy in the energy store 15 to enable the data communication and energy transfer via the antenna coil 12, and without the need for renewed manual actuation of the first switch 13.

Furthermore, the energy from the energy store 15 can be used to operate the measuring device 17 totally independently of the energy available via the antenna coil 12.

FIG. 4a shows an alternative variant of the embodiment of the invention illustrated in FIG. 4, in which the measuring device 17 is connected to the NFC communication unit 11 and the antenna coil 12, such that the measuring device 17 is supplied with energy directly by the antenna coil 12.

FIG. 5 shows a schematic illustration of an alternative variant of an NFC transponder assembly 10 according to the invention, wherein the NFC transponder assembly 10 comprises an NFC communication unit 11, a microcontroller 19, a control unit 20, a mechanical first switch 13, an electrical second switch 14 and an antenna coil 12.

In the exemplary embodiment, the microcontroller 19 is connected to the NFC communication unit 11 and the control unit 20. The control unit 20 is directly connected to the terminals of the antenna coil 12, such that the control unit 20 can draw energy from the antenna coil 12 even when the first switch 13 and the second switch 14 are open. The control unit 20 is furthermore configured to drive and to close the second switch 14 after driving by the microcontroller 19.

This configuration of the NFC transponder assembly 10 advantageously enables the electrical second switch 14 to be closed independently of the NFC communication unit 11, i.e. without manual actuation of the first switch 13 being required beforehand.

FIG. 6 shows a data communication device 2 comprising an NFC transponder assembly 10 according to the invention, a further NFC communication unit 21, and also a further antenna coil 22. The further antenna coil 22 is connected to the further NFC communication unit 21 and is arranged in the near range of the antenna coil 12 of the NFC transponder assembly 10 and/or is connected thereto. In this case, the antenna coil 12 can be permanently arranged in the near range of the further antenna coil 22 by virtue of the NFC transponder assembly 10 being fixed on the data communication device 2, for example by being plugged or adhesively bonded thereon. In the exemplary embodiment illustrated in FIG. 6, the NFC transponder assembly 10 is advantageously arranged on a removable label, such that the NFC transponder assembly 10 is able to be fixed to the data communication device 2 by being adhesively bonded thereon, and is releasable again.

This embodiment is suitable, for example, for utilizing a cellular phone as a mobile measuring unit by adhesively bonding thereon an NFC transponder assembly 10 according to the invention comprising a measuring device 17. In this case, the further antenna coil 22 of the data communication device 2 is coupled to the antenna coil 12, such that upon activation of the antenna coil 12, there is an NFC communication connection and data can be transferred, for example, between the NFC communication unit 11 and the further NFC communication unit 21 via the antenna coils 12 and the further antenna coil 22. In this case, the antenna coil 12 can be activated as described above, e.g. by manual actuation of a first switch 13 contained in the NFC transponder assembly 10 or the closing of an electrical second switch 14 by driving by the NFC communication unit 11.

In order to enable the data communication device 2 for establishing some other NFC communication after a measurement process, it is possible, as described above, for the NFC communication unit 11 to be configured to open the second switch 14 again, such that the antenna coil 12 is deactivated.

FIG. 7 schematically illustrates a further exemplary embodiment of an NFC transponder assembly 10 according to the invention comprising an energy drawing device 18. The exemplary embodiment shown comprises an antenna coil 12, an NFC communication unit 11, a first switch 13, an electrical second switch 14, a measuring device 17, an energy store 15 and the energy drawing device 18, wherein the energy drawing device 18 is directly connected to two terminals 12a, 12b of the antenna coil 12. In the exemplary embodiment, the first switch 13 is embodied as a switch to be actuated manually.

In the exemplary embodiment, the NFC communication unit 11 has two terminals 11a and 11b, wherein the first terminal 11a is connected to a first terminal 13a of the first switch 13 and a second terminal 13b of the switch 13 is connected to the first terminal 12a of the antenna coil 12. The second switch 14 is connected between the terminals 13a and 13b and a first terminal 18a of the energy drawing device 18 is connected between the first switch 14 and the second terminal 13b of the first switch 13. In the exemplary embodiment, the second terminal 11b is connected to the second terminal 12b of the antenna coil 12 via a second terminal 18b of the energy drawing device 18.

The measuring device 17 is connected to the NFC communication unit 11 and the energy drawing device 18 is connected to the NFC communication unit 11 and to the second switch 14. The NFC communication unit 11 and the energy drawing device 18 are configured to control the second switch 14, such that the latter is closed.

If the first switch 13 and the second switch 14 are not actuated or closed, no NFC connection is established between the NFC transponder assembly 10 and a data communication device 2 situated in the near range of the NFC transponder assembly 10, since the antenna coil 12 is not activated and the NFC communication unit 11 is disconnected from the antenna coil 12.

The data communication device 2 nevertheless emits a polling pulse regularly, typically four to five times per second, in order to establish an NFC communication with an NFC transponder assembly 10 possibly situated in the near range of the data communication device 2. These pulses emitted by the data communication device 2 pass into the antenna coil 12 and the energy drawing device 18 collects these pulses and accumulates the charge in the energy store 15.

The energy drawing device 18 is configured to rectify voltage, to collect charges and to store them in an energy store 15 contained in the energy drawing device 18. Furthermore, the energy drawing device 18 is configured to ascertain the state of charge and to compare it with threshold values, to transmit control signals and/or to output the stored energy in a controlled manner.

Provision can be made for the energy drawing device 18 to drive a microcontroller 19 contained in the NFC communication unit 11 at predefined time intervals, such that the microcontroller 19 in turn drives the measuring device 17, such that the latter carries out a measurement and buffer-stores a measurement value determined in a data memory of the NFC communication unit 11. It is thus advantageously possible for measurement data to be logged without an external power supply and without the need for the NFC communication to be continuously maintained via the antenna coil 12.

A plurality of minutes can be provided as time intervals, for example, that is to say that the NFC communication unit is driven by the energy drawing device 18 usually when a sufficient energy level is present in the energy store 15 of the energy drawing device 18.

The measurement values stored in the NFC communication unit 11 can be transferred to the data communication device 2 either at the same time as the measurement acquisition, or later, by manual actuation of the first switch 13. Alternatively, provision can also be made for the energy drawing device 18 to be configured to close the second switch 14 automatically, for example if the state of charge of the energy store 15 of the energy drawing device 18 reaches a predefined threshold value.

Provision can also be made for the energy drawing device 18 to be configured, after a predefined number of instances of driving on the part of the microcontroller 19 of the NFC communication unit 11, i.e. once a number of measurement values corresponding to said number are present in the data memory of the NFC communication unit 11, to transfer them to the data communication device 2.

Alternatively, it can also be provided that for example when enough energy is present in the energy store 15 of the energy drawing device 18, the energy drawing device 18 drives the NFC communication unit 11 to close the second switch 14, such that the NFC communication unit 11 is connected to the antenna coil 12 and the microcontroller 19 of the NFC communication unit 11 can draw energy from the antenna coil 12 as well.

Since even a small amount of collected energy in the energy store 15 of the energy drawing device 18 is sufficient to close the second switch 14, this configuration advantageously enables sampling rates with smaller time intervals, although in this case the antenna coil 12 is more often in use for an NFC communication and as a result is blocked for other applications.

In all of the exemplary embodiments described above, the first switch 13 can be configured in various ways:

By way of example, a pressure-sensitive switch or pushbutton switch can be provided as the first switch 13, wherein the switch closes upon pressure being exerted. Alternatively, the first switch 13 can also be configured as a switch which is controlled by a sensor and which closes if a measurement value exceeds a predefined threshold value. As the first switch 13, provision can be made of a light-sensitive switch, for example, which closes when light is incident on the sensor.

A further possible variant of a first switch 13 is an external proximity switch, that is to say that in this case the first switch 13 is configured to react to the approach of a trigger in a manner free of contact, without direct contact with the trigger being required. In this case, in particular, a resistive or inductive or capacitive proximity switch can be provided, such that metallic objects but also nonmetallic materials are suitable as trigger, for example.

However, the first switch 13 can also be configured as an open electrode pair, wherein the open electrode pair in this case is configured in such a way that when a conductive liquid is present in the region of the electrodes, current flows between the two electrodes of the open electrode pair, in particular in such a way that the antenna coil 12 is activated and ready for data transfer.

Alternatively, it can also be provided that the antenna coil 12 is detuned and when an object or a liquid having an increased permittivity in comparison with air is present, the open electrode pair changes its capacitance in such a way that the antenna coil 12 is tuned to a predefined resonant frequency and in this way the antenna coil 12 is activated and in particular is ready for data transfer.

Various configuration variants are also possible when the first switch 13 is incorporated into the electrical circuit of an NFC transponder assembly 10 according to the invention: by way of example, as the first switch 13, provision can also be made of a switch which is connected in series with the antenna coil 12 and which is configured to activate the antenna coil 12 upon actuation.

As illustrated in FIG. 8, alternatively, a first switch 13 connected in parallel with the antenna coil 12 can also be provided. The exemplary embodiment shown in FIG. 8 comprises an antenna coil 12 having two terminals 12a, 12b, an NFC communication unit 11, a first switch 13 configured as a break-contact switch, and a resistor 3. The first switch 13 is closed in the unactuated state and short-circuits the antenna coil 12 via the resistor 3.

The short-circuiting of the antenna coil 12 ensures that between the two terminals 12a, 12b of the antenna coil 12 the induced current flows via the resistor and is not available to the communication unit 11, as a result of which the latter remains inactive.

The first switch 13 configured as a break-contact switch is furthermore configured to open upon actuation. As a result of the opening of the first switch 13, the antenna coil 12 supplies the communication unit 11 with electrical energy, as a result of which it is possible to establish an NFC communication.

Alternatively, in an NFC transponder assembly 10 according to the invention, by way of example, provision can also be made of a further circuit element 31, in particular a coil or a capacitor, which can be connected in parallel or in series with the antenna coil 12 (FIG. 9). In this case, the first switch 13 is configured, upon actuation, to activate the further circuit element 31, which tunes the antenna coil 12 to the corresponding carrier frequency, such that the antenna coil 12 is activated and in particular is ready for data communication. In the non-activated state of the first switch 13, by contrast, the antenna coil 12 is detuned and therefore cannot be used for communication.

In the exemplary embodiment in FIG. 9, the first switch 13 is embodied as a make-contact switch connected in parallel with the antenna coil 12, and the additional circuit element 31 is embodied as a coil. The antenna coil 12 is detuned in the initial state, as a result of which no NFC communication or energy transfer is possible via the antenna coil 12 in the initial state. Upon actuation of the first switch 13, the coil 31 is switched on. As a result of the coil 31 being switched on, the antenna coil 12 is tuned to the corresponding carrier frequency and it is possible to establish an NFC communication.

1-17. (canceled)

18. An NFC transponder assembly (10), comprising:
an NFC communication unit (11);
an antenna coil (12) connected to said NFC communication unit (11), said antenna coil (12) configured for supplying energy from an electromagnetic field in a region of said antenna coil (12) and establishing NFC communication with a data communication device (2) via said antenna coil (12);
a first switch (13) configured to be actuated for activating said antenna coil (12);
a second switch (14) being open in an inactive state, said second switch (14) being configured as an electrical switch and being disposed in parallel with said first switch (13);
said second switch (14) being closed after the actuation of said first switch (13) and being kept closed for a time period after an end of the actuation of said first switch (13), for activating said antenna coil (12) for said time period and rendering said antenna coil (12) ready for data transfer; and
said second switch (14) being opened after the end of said time period for deactivating said antenna coil (12) and rendering said antenna coil (12) not ready for data transfer.

19. The NFC transponder assembly according to claim 18, wherein said first switch (13) is connected in series with said antenna coil (12), and said first switch (13) is configured to activate said antenna coil (12) upon actuation.

20. The NFC transponder assembly according to claim 18, wherein said first switch (13) is connected in parallel with said antenna coil (12) and is configured to short-circuit said antenna coil (12) in an initial state and to open upon actuation and activate said antenna coil (12).

21. The NFC transponder assembly according to claim 20, which further comprises a resistor (3) short-circuiting said antenna coil (12).

22. The NFC transponder assembly according to claim 18, which further comprises:
at least one of said second switch (14) or said first switch (13) being configured as an all-pole switch including two respective second switch elements (14′, 14″) or two respective first switch elements (13′, 13″);
said antenna coil (12) having two terminals (12a, 12b);
said NFC communication unit (11) having two terminals (11a, 11b);
at least one of said second switch elements (14′, 14″) or said first switch elements (13′, 13″) connecting said two terminals (12a, 12b) of said antenna coil (12) to said two terminals (11a, 11b) of said NFC communication unit (11); and
at least one of said second switch elements (14′, 14″) or said first switch elements (13′, 13″) being closed simultaneously upon actuation. (FIG. 3)

23. The NFC transponder assembly according to claim 18, which further comprises a further circuit element (31), coil or capacitor, said first switch (13) being configured to activate said further circuit element (31), coil or capacitor upon actuation and to tune said antenna coil (12) to a predefined resonant frequency as a result of the activation of said further circuit element (31), coil or capacitor for activating said antenna coil (12) and rendering said antenna coil (12) ready for data transfer.

24. The NFC transponder assembly according to claim 18, wherein:
said antenna coil (12) has two terminals (12a, 12b);
said NFC communication unit (11) has at least two terminals for said antenna coil (12);
said first switch (13) has one terminal (13a) connected to one of said terminals (11a) of said NFC communication unit (11);
said first switch (13) has another terminal (13b) connected to one of said terminals (12a) of said antenna coil (12); and
another terminal (12b) of said antenna coil (12) is connected to said other terminal (11b) of said NFC communication unit (11). (FIG. 2)

25. The NFC transponder assembly (10) according to claim 18, wherein at least one of:
said first switch (13) being formed by an open electrode pair, said open electrode pair being formed to permit current to flow between two electrodes of said open electrode pair to activate said antenna coil (12) and render said antenna coil (12) ready for data transfer, when a conductive liquid is present in a region of the electrodes; or
said antenna coil (12) being detuned and causing said first switch (13) to change its capacitance and to tune said antenna coil (12) to a predefined resonant frequency for activating said antenna coil (12) and rendering said antenna coil (12) ready for data transfer, when an object or a liquid having an increased permittivity in comparison with air is present.

26. The NFC transponder assembly (10) according to claim 18, which further comprises an energy store (15) for storing energy provided by said antenna coil (12). (FIGS. 4, 4a)

27. The NFC transponder assembly (10) according to claim 26, wherein at least one of:
said first switch (13) is a pressure-sensitive switch or pushbutton switch closing upon pressure being exerted; or
said first switch (13) is a sensor-controlled switch or light-sensitive switch configured to close when a measurement value determined by a sensor exceeds a predefined threshold value or when light is incident on said sensor;
said sensor is connected to said energy store (15) to supply a measuring device with energy for determining a measurement value contained in said sensor; or
said first switch (13) is an external proximity switch or a resistive proximity switch or a capacitive proximity switch or an inductive proximity switch.

28. The NFC transponder assembly (10) according to claim 26, which further comprises an indicator unit (16) configured to indicate a presence of available energy stored in said energy store (15) or present at said antenna coil (12). (FIGS. 1, 4)

29. The NFC transponder assembly (10) according to claim 18, which further comprises:
an energy drawing device (18) for drawing energy from said antenna coil (12);
said antenna coil (12) having two terminals (12a, 12b) directly connected to said energy drawing device (18);
an energy store (15) providing energy to be stored in said energy drawing device (18); and
said energy drawing device (18) being configured to control said second switch (14) in case of a sufficient state of charge to close said second switch and to interconnect said NFC communication unit (11) and said antenna coil (12). (FIG. 7)

30. The NFC transponder assembly (10) according to claim 18, which further comprises a measuring device (17) for determining a measurement variable, said measuring device being connected to said NFC communication unit (11), and said measuring device (17) having an output and being configured to transmit measurement results present at said output of said measuring device (17) upon a request to the data communication device (2) via said antenna coil (12). (FIG. 4a)

31. The NFC transponder assembly (10) according to claim 30, which further comprises:
an energy store (15) for storing energy provided by said antenna coil (12);
said measuring device (17) being connected to said energy store (15) or being supplied with energy directly by said antenna coil (12) and being supplied with electrical energy by said antenna coil (12) during a measurement process.

32. The NFC transponder assembly (10) according to claim 31, wherein said NFC communication unit (11) is configured to activate said measuring device (17) and to open said second switch (14) after a predefined time period, said predefined time period corresponding to a time required by said measuring device (17) to carry out at least one of a measurement or a data transfer.

33. The NFC transponder assembly (10) according to claim 32, wherein said NFC communication unit (11) is configured to close said second switch (14) once again, after the opening of said second switch (14), by using the energy stored in said energy store (15).

34. A data communication device (2), comprising:
an NFC transponder assembly (10) according to claim 18;
a further NFC communication unit (21); and
a further antenna coil (22) connected to said further NFC communication unit (21), said further antenna coil (22) being at least one of disposed in a region of said antenna coil (12) of said NFC transponder assembly (10) or connected and coupled to said antenna coil (12) of said NFC transponder assembly (10), to provide a communication link between said NFC communication unit (11) and said further NFC communication unit (21) via said antenna coil and said further antenna coil (12, 22) upon activation of said antenna coil (12) of said NFC transponder assembly (10).

35. The data communication device (2) according to claim 34, wherein said further antenna coil (22) is at least one of permanently disposed in said region of said antenna coil (12) of said NFC transponder assembly (10) or permanently connected and coupled to said antenna coil (12) of said NFC transponder assembly (10).

36. The data communication device (2) according to claim 34, wherein:
said NFC transponder assembly (10) is fixed or adhesively bonded or plugged on the data communication device (2) for permanently placing said antenna coil (12) a near range of said further antenna coil (22), and
said NFC transponder assembly (10) is disposed on an adhesive label adhesively bonded onto the data communication device (2) or on a protective cover fitted on the data communication device (2) or on a plug-on unit fitted on the data communication device (2).
